(19) United States
(12) Patent Application Publication
(10) Pub. No.: US 2025/0076869 A1
(43) Pub. Date: Mar. 6, 2025

(54) METHOD, SYSTEM AND STORAGE MEDIUM FOR FAULT DIAGNOSIS OF MECHANICAL EQUIPMENT

(71) Applicant: Aktiebolaget SKF, Göteborg (SE)

(72) Inventors: Jinshi CUI, Shanghai (CN); Kaihuan ZHANG, Hangzhou (CN)

(21) Appl. No.: 18/818,784

(22) Filed: Aug. 29, 2024

(30) Foreign Application Priority Data
Aug. 30, 2023 (CN) 202311112206.9

(51) Int. Cl. G05B 23/02; G06N 20/00

(52) U.S. Cl. CPC G05B 23/0281; G05B 23/0245; G06N 20/00

(57) ABSTRACT

A method, a system and a storage medium for fault diagnosis of mechanical equipment. The method comprises the following steps: obtaining data about the mechanical equipment, determining that the data about the mechanical equipment belongs to known operating conditions by an anomaly detection model, determining an operating condition of the data about the mechanical equipment by the classification model, and selecting a diagnosis model for diagnosis based on the operating condition of the data about the mechanical equipment. According to the fault diagnosis method of mechanical equipment disclosed by the present disclosure, accurate fault diagnosis results can be provided even when the mechanical equipment is in different operating conditions.

### CROSS-REFERENCE TO RELATED APPLICATION

This application claims priority to Chinese Application No. 202311112206.9, filed on Aug. 30, 2023, the entirety of which is hereby incorporated by reference.

### FIELD

The present disclosure relates to a method, a system and storage medium for fault diagnosis of mechanical equipment.

### BACKGROUND

During the operation of various mechanical equipment, some use failures will inevitably occur. At present, in order to diagnose mechanical equipment faults, maintenance engineers can evaluate mechanical equipment faults by measuring relevant data when mechanical equipment is running/stopping. However, depending on the qualifications of maintenance engineers, there is great uncertainty in evaluating mechanical equipment through maintenance engineers. In addition, because mechanical equipment may be in different operating conditions (that is, operating mode), it may be a great challenge to accurately diagnose mechanical equipment faults. Therefore, there is a need for a method for fault diagnosis of mechanical equipment according to its operating conditions.

### SUMMARY

According to an embodiment of the present disclosure, there is provided a 1. A fault diagnosis method for mechanical equipment, comprising: obtaining data about the mechanical equipment, determining that the data about the mechanical equipment belongs to known operating conditions by an anomaly detection model, determining an operating condition of the data about the mechanical equipment by the classification model, and selecting a diagnosis model for diagnosis based on the operating condition of the data about the mechanical equipment.

The method according to the embodiment of this disclosure, wherein the anomaly detection model comprises one or more of the following: a statistical model and an anomaly detection model using machine learning, wherein the anomaly detection model using machine learning includes one or more of a distribution-based machine learning model, a distance-based machine learning model, a density-based machine learning model, a clustering-based machine learning model, a tree-based machine learning model, a dimensionality reduction-based machine learning model, a classification-based machine learning model and a prediction-based machine learning model.

The method according to the embodiment of this disclosure, wherein the classification model comprises one or more of the following: a data correlation model and a classification model using machine learning, wherein the classification model using machine learning is based on one or more of decision tree, random forest, logistic regression and naive Bayes.

The method according to the embodiment of this disclosure, wherein the diagnosis model, the anomaly detection model and the classification model are trained by using previously obtained data about the mechanical equipment.

The method according to the embodiment of this disclosure, wherein obtaining the data about the mechanical equipment further comprises obtaining features of the data about the mechanical equipment, and, wherein the features of the data about the mechanical equipment are obtained by one or more of the following: root mean square (RMS), peak-to-peak (P2P), average, standard deviation, envelope 3 (Envolop3), time-frequency transformation, numerical operation.

The method according to the embodiment of this disclosure, further comprising: determining that the data about the mechanical equipment does not belong to the known operating conditions, reporting the data about the mechanical equipment.

The method according to the embodiment of this disclosure, wherein reporting the data about the mechanical equipment further comprises: determining whether the data about the mechanical equipment is a new operating condition, in a case of determining that the data about the mechanical equipment is the new operating condition, the new operating condition is added to the known operating conditions, in a case of determining that the data about the mechanical equipment is not the new operating condition, the data about the mechanical equipment is discarded.

The method according to the embodiment of this disclosure, further comprising: developing a new diagnostic model based on the data about the mechanical equipment belonging to the new operating conditions, and updating the anomaly detection model and the classification model based on the data about the mechanical equipment belonging to the known operating conditions including the new operating conditions.

The method according to the embodiment of this disclosure, wherein the operating conditions are associated with one or more operating parameters of the mechanical equipment.

According to an embodiment of the present disclosure, there is provided a fault diagnosis system for mechanical equipment, comprising: a sensor unit including one or more sensors and configured to collect data about the mechanical equipment; an anomaly detection model configured to determine that data about the mechanical equipment belongs to known operating conditions; a classification model configured to select a diagnosis model based on operating conditions of data about mechanical equipment; a diagnosis model library including one or more diagnosis models configured to diagnose the mechanical equipment; and a processor configured to: obtaining the data about the mechanical equipment from the sensor unit, determining that the data about the mechanical equipment belongs to known operating conditions using the anomaly detection model, determining an operating condition of the data about the mechanical equipment using the classification model, and selecting a diagnosis model for diagnosis based on the operating condition of the data about the mechanical equipment from the diagnosis model library.

According to an embodiment of the present disclosure, a non-transitory storage medium is provided, on which instructions are stored, which, when executed by a processor, cause the processor to perform the fault diagnosis method of mechanical equipment as described above.

According to the fault diagnosis method of mechanical equipment disclosed by the present disclosure, accurate fault diagnosis results can be provided even when the mechanical equipment is in different operating conditions.

### BRIEF DESCRIPTION OF DRAWINGS

The above and other aspects, features and advantages of specific embodiments of the present disclosure will become more apparent from the following description taken in conjunction with the accompanying drawings, in which:

FIG. 1a is a flowchart of a diagnosis method according to an embodiment of the present disclosure.

FIG. 1b is a flowchart of another diagnosis method according to an embodiment of the present disclosure.

FIG. 1c is a flowchart of yet another diagnosis method according to an embodiment of the present disclosure.

FIG. 2a is a diagram of an operating condition and a diagnosis model according to an embodiment of the present disclosure.

FIG. 2b is another diagram of an operating condition and a diagnosis model according to an embodiment of the present disclosure.

FIG. 2c is yet another diagram of an operating condition and a diagnosis model according to an embodiment of the present disclosure.

FIG. 3 is a schematic diagram of a system according to an embodiment of the present disclosure.

### DETAILED DESCRIPTION

Before proceeding to the following detailed description, it may be beneficial to set forth the definitions of certain words and phrases used throughout this patent application document. The terms “including” and “containing” and their derivatives refer to including but not limited to. The term “controller” or “control unit” refers to any device, system or part thereof that controls at least one operation. Such a controller may be implemented in hardware or a combination of hardware and software and/or firmware. The functions associated with any particular controller can be centralized or distributed, whether local or remote. The phrase “at least one”, when used with a list of items, means that different combinations of one or more of the listed items can be used, and only one item in the list may be needed. For example, “at least one of a, b and c” includes any one of the following combinations: a, b, c, a and b, a and c, b and c, a and b and c.

Definitions of other specific words and phrases are provided throughout this patent application document. It should be understood by those skilled in the art that in many cases, if not most cases, this definition also applies to the previous and future uses of words and phrases so defined.

The following description of various embodiments of the principles of the present disclosure in this patent application document with reference to the accompanying drawings is for illustration only and should not be interpreted as limiting the scope of the present disclosure in any way. Those skilled in the art will understand that the principles of the present disclosure can be implemented in any suitably arranged system or device. In some cases, the actions described in the specification can be performed in a different order and still achieve the desired results. Moreover, the processes depicted in the drawings do not necessarily require the specific order shown or sequential order to achieve the desired results. In certain embodiments, multitasking and parallel processing may be advantageous.

Mechanical equipment used throughout this disclosure may include all kinds of general and special mechanical equipment, including but not limited to machine tools (e.g., lathes, drilling machines, boring machines, grinders, gear processing machines, thread processing machines, milling machines, planers, broaching machines, sawing machines and other machine tools, etc.), processing and manufacturing equipment (e.g., food processing equipment, textile equipment, chemical equipment, assembly equipment, etc.), and carriers (e.g. motor vehicles, ships, aircraft, public transport vehicles, construction equipment, agricultural equipment, intelligent agents such as robots, etc.) and their components (for example, engines, motors, reducers, bearings, vehicle chassis, robot bodies, etc.), construction traffic machinery and equipment (for example, pipelines, tracks, catenary (rails), etc.).

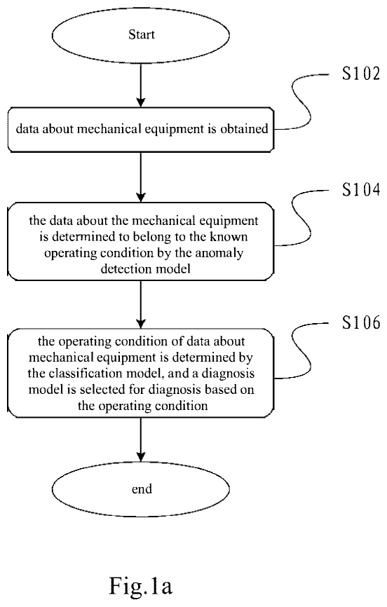

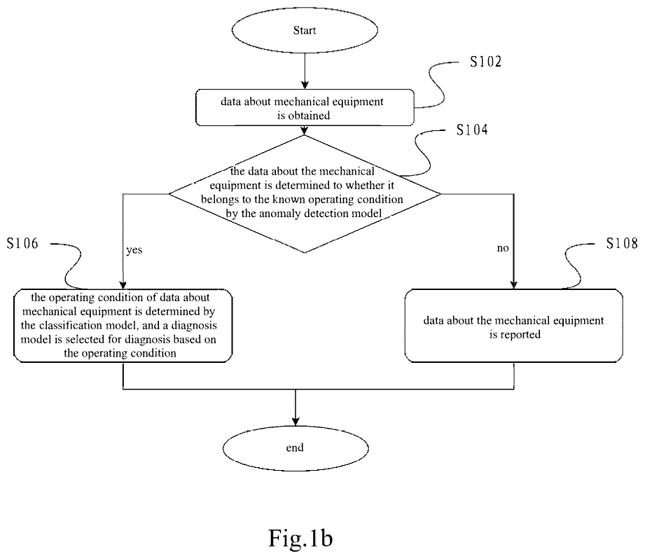

FIG. 1a is flowchart of a diagnosis method according to an embodiment of the present disclosure.

At S102, data about mechanical equipment can be obtained. The obtained data about the mechanical equipment can be collected by the sensor unit, and can include vibration, sound, temperature, chemical composition, image, pressure, current, voltage, speed and other data.

In S104, the data about the mechanical equipment is determined to belong to the known operating condition by the anomaly detection model. Known operating conditions may be several operating conditions determined based on previously collected data about mechanical equipment. For example, the operating conditions can be related to the operating parameters of mechanical equipment.

At S106, the operating condition of data about mechanical equipment can be determined by the classification model, and a diagnosis model can be selected for diagnosis based on the operating condition. For example, when it is determined that the data about mechanical equipment belongs to a certain operating condition (for example, a certain operating speed), a diagnosis model that also belongs to the operating condition (for example, the operating speed) can be selected for diagnosis.

FIG. 1b is a flowchart of another diagnosis method according to an embodiment of the present disclosure.

Similar to S102 of FIG. 1a, in S102 of FIG. 1b, data about mechanical equipment can be obtained.

In S104, it can be determined whether the data about the mechanical equipment belongs to the known operating conditions through the anomaly detection model. Known operating conditions may be several operating conditions determined based on previously collected data about mechanical equipment. For example, the operating conditions can be related to the operating parameters of mechanical equipment. The anomaly detection model can be used to define the known operating conditions as the same class. Anomaly detection models can include statistical models, anomaly detection models using machine learning and other models. It can be determined whether the data about mechanical equipment belongs to this class through the anomaly detection model including statistical model, anomaly detection model using machine learning and other various models, so as to determine whether the data about mechanical equipment belongs to known operating conditions. The anomaly detection model can be trained using previously obtained data about mechanical equipment belonging to existing operating conditions (for example, feature of data about mechanical equipment belonging to existing operating conditions). Among them, the features of data about mechanical equipment belonging to the existing operating conditions can be extracted by root mean square (RMS), peak-to-peak (P2P), mean value, standard deviation, envelope 3 (Envolop3), time-frequency transformation (such as FFT transformation), numerical operation and so on. For example, the known operating conditions can be ten operating conditions, and the anomaly detection model using machine learning can be trained by data belonging to the ten operating conditions, but the disclosure is not limited to this.

In one embodiment, the statistical model can be a relatively lightweight model based on statistical principles. Statistical model can evaluate the probability of some feature values in the obtained data about mechanical equipment, and determine whether the data about mechanical equipment belongs to known operating conditions by comparing the probability of feature values with the threshold probability. In some cases, statistical models can occupy relatively less memory space, require lower computing power and run faster.

In one embodiment, the anomaly detection model using machine learning may include a distribution-based machine learning model (such as 3sigma, Z-score, boxplot, etc.), a distance-based machine learning model (such as K nearest neighbor (KNN)), a density-based machine learning model (such as Local Outlier Factor, LOF, connectivity-based outlier factor (COF), Stochastic Outlier Selection (SOS), etc.), cluster-based machine learning model (such as, Density-based spatial clustering of applications with noise (DBSCAN, etc.)), tree-based machine learning models (such as Isolation Forest, iForest, etc.), dimensionality reduction-based machine learning models (such as, Principal Component Analysis (PCA), AutoEncoder, etc.), classification-based machine learning model (such as One-Class SVM, etc.), prediction-based machine learning model (such as, Moving Average, autoregressive integrated moving average model (ARIMA), etc.). Although the example embodiment shows some anomaly detection models using machine learning, those skilled in the art should understand that the above description is only exemplary and not exhaustive, and other models for anomaly detection existing or developed in the future can be used to determine whether the data about mechanical equipment belongs to known operating conditions, all of which are within the contemplation of this disclosure. In some cases, the types of anomaly detection models using machine learning are relatively richer, and the anomaly detection results obtained are more accurate.

In one embodiment, the statistical model and the anomaly detection model using machine learning can be run in series or in parallel. In another embodiment, when the confidence of the results obtained by the statistical model is insufficient, an anomaly detection model using machine learning can be used.

If the data about the mechanical equipment belongs to a known operating conditions, the flow proceeds to S106. At S106, the operating condition of data about mechanical equipment can be determined by the classification model, and a diagnosis model can be selected for diagnosis based on the operating condition. For example, when it is determined that the data about mechanical equipment belongs to a certain operating condition (for example, a certain operating speed), a diagnosis model that also belongs to the operating condition (for example, the operating speed) can be selected for diagnosis. The diagnosis model can correspond to the existing operating conditions respectively. For example, in the embodiment where the known operating conditions are ten operating conditions, there may be ten diagnostic models, which respectively correspond to ten existing operating conditions, but the present disclosure is not limited to this. For example, a diagnostic model belonging to a certain operating condition can be trained by using previously obtained data about mechanical equipment also belonging to the operating condition (for example, the features of the data about mechanical equipment belonging to the operating condition). Because the data of mechanical equipment under different operating conditions may be quite different, choosing the diagnosis model under the same operating conditions can improve the accuracy of diagnosis results.

In one embodiment, the selection of the diagnosis model based on the operating conditions can be made by the classification model. For example, the classification model may include a classification model using machine learning, a data correlation model, or any other model. For example, in the embodiment where the known operating conditions are ten operating conditions, the classification model can be trained by previously obtained data belonging to the ten operating conditions (e.g., features of data about mechanical equipment belonging to the ten operating conditions), but the disclosure is not limited to this. Among them, the features of data about mechanical equipment belonging to the ten operating conditions can be extracted by root mean square (RMS), peak-to-peak (P2P), average value, standard deviation, envelope 3 (Envolop3), time-frequency transformation (such as FFT transformation), numerical operation and so on.

In one embodiment, the data correlation model may correspond to a data/signal preprocessing method. For example, the data correlation model can be used to obtain the correlation between the data about mechanical equipment and the data of known operating conditions, so as to select the diagnosis model corresponding to the known operating conditions with high correlation based on the correlation ranking. In some cases, the data correlation model can occupy relatively less memory space, require lower computing power and run faster.

In one embodiment, the classification model using machine learning can be based on decision tree, Random Forest, Logistic regression, Naive Bayes, etc. Although the example embodiment shows some classification models using machine learning, those skilled in the art should understand that the above description is only exemplary and not exhaustive, and other existing or future developed models for classification can be used to determine the known operating conditions to which the data about mechanical equipment belongs, all of which are within the contemplation of this disclosure. In some cases, the types of classification models using machine learning are relatively richer, and the results of classification are more accurate.

In one embodiment, the data correlation model and the classification model using machine learning can be run in series or in parallel. In another embodiment, when the confidence of the results obtained through the data correlation model is insufficient, a classification model using machine learning can be used.

If the data about the mechanical equipment does not belong to the known operating condition, the flow proceeds to S108. At S108, data about the mechanical equipment can be reported. For example, the data of the mechanical equipment can be reported to a service factory including a human operator for further processing.

FIG. 1c is a flowchart of yet another diagnosis method according to an embodiment of the present disclosure.

In order to be concise and avoid unnecessary confusion, the same parts in FIG. 1c as those in FIG. 1b are not repeated.

In S110, it can be determined whether the data about the mechanical equipment is a new operating condition. For example, the data about the mechanical equipment can be determined as a new operating condition based on the data about the mechanical equipment (e.g., its features). In this case, at S112, a new operating condition can be added to the known operating conditions. In this way, a new diagnosis model can be developed based on the data about mechanical equipment belonging to new operating conditions. In addition, the anomaly detection model and the classification model can be updated based on the data about mechanical equipment belonging to known operating conditions including new operating conditions.

In the case that it is determined that the data about the mechanical equipment is not a new operating condition, the flow proceeds to S114, and the data about the mechanical equipment can be discarded. For example, if it is determined that the data about the mechanical equipment is noise, the data can be discarded without further analysis.

Through this iterative way, the known operating conditions and diagnosis models can be continuously expanded, thus providing a diagnosis model that is more matched with the data about mechanical equipment and making the diagnosis results more accurate.

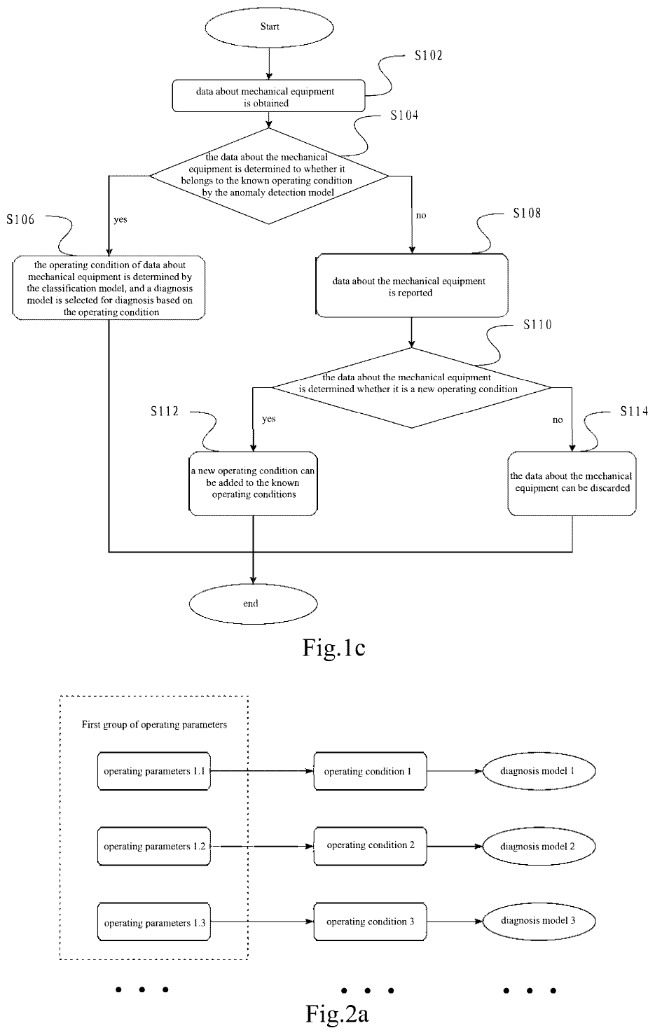

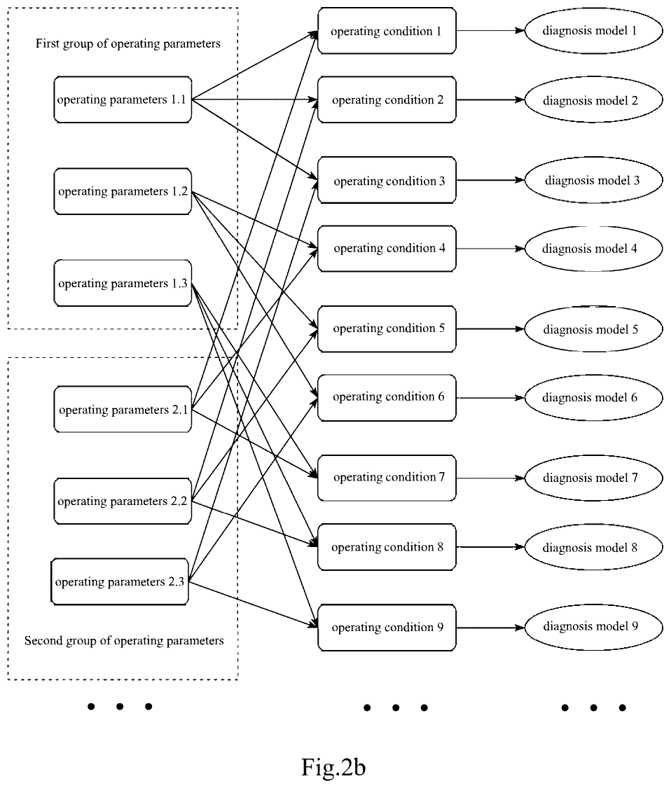

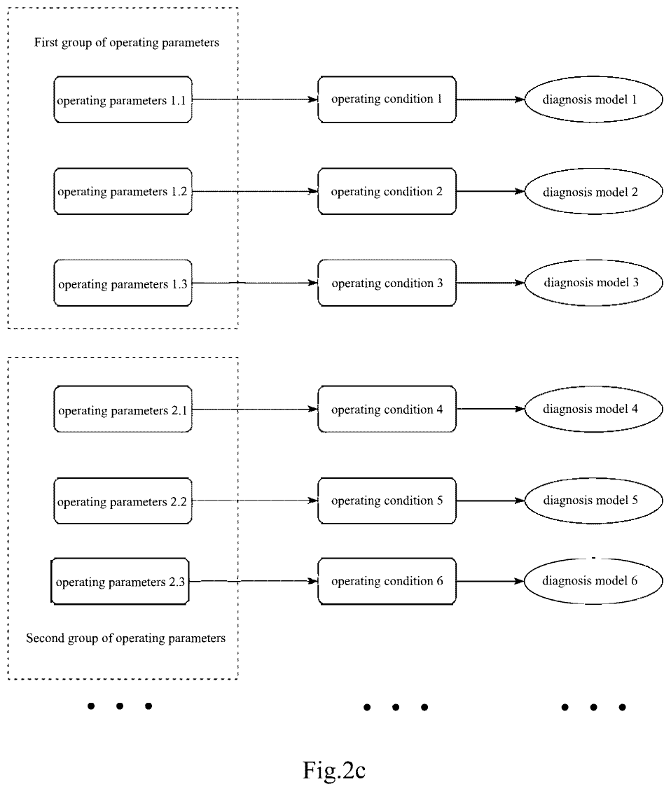

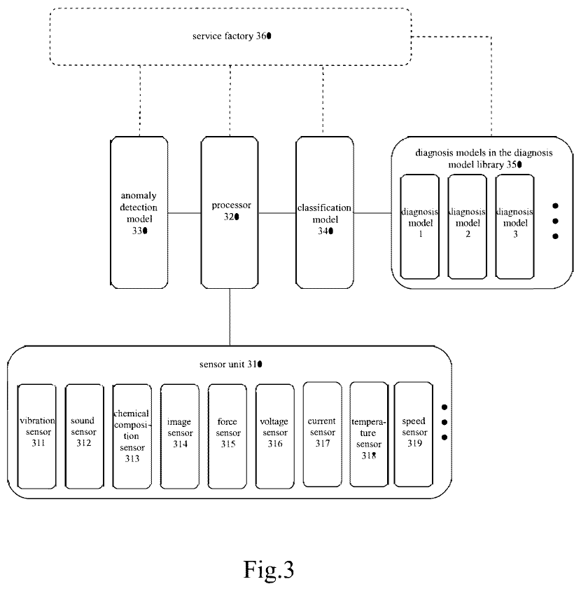

FIG. 2a is a diagram of operating conditions and a diagnosis models according to an embodiment of the present disclosure.

As shown in FIG. 2a, in an embodiment where an example machine device has a group of operating parameters, the operating conditions may be associated with a group of operating parameters. In the embodiment where the mechanical equipment is a machine tool, the first group of operating parameters can be the rotational speed of the machine tool, where the operating parameter 1.1 can be the rotational speed 1, the operating parameter 1.2 can be the rotational speed 2 lower than the rotational speed 1, and the operating parameter 1.3 can be the rotational speed 3 lower than the rotational speed 2. In other embodiments, the operating parameters of a group may include more or less operating parameters. Operating conditions 1-3 may correspond to operating parameters 1.1-1.3, respectively. The diagnosis models can correspond to operating conditions respectively, for example, diagnosis model 1—diagnosis model 3 correspond to operating conditions 1-3 respectively.

In other embodiments, the operating parameters can be determined according to the type of mechanical equipment. For example, in an embodiment of a vehicle, the operating parameters may include vehicle speed, road gradient, vehicle load, and the like. In an embodiment of the robot, the operation parameters may include the number of bodies operated by the robot and the type of actions performed by the robot. But the present disclosure is not limited thereto.

In one embodiment, the rotational speed of the machine tool is rotational speed 2, so as described with reference to FIGS. 1a-1c, it can be determined that the data about the mechanical equipment belongs to the existing operating condition through the anomaly detection model, and it can be determined that the data about the mechanical equipment belongs to operating condition 2 through the classification model, so that the diagnosis model 2 can be selected for diagnosis to obtain the diagnosis result. The diagnostic model 2 can be trained using data belonging to the operating condition 2.

FIG. 2b is another diagram of operating conditions and a diagnosis models according to an embodiment of the present disclosure.

As shown in FIG. 2b, in an embodiment where the example mechanical equipment has more than one group of operating parameters, each operating condition may be associated with more than one group of operating parameters. For example, an example machine may have two groups of operating parameters including a first group of operating parameters and a second group of operating parameters. In other embodiments, example mechanical equipment may have more groups of operating parameters. In the embodiment where the mechanical equipment is a machine tool, the first group of operating parameters can be the rotational speed of the machine tool, where the operating parameter 1.1 can be the rotational speed 1, the operating parameter 1.2 can be the rotational speed 2 lower than the rotational speed 1, and the operating parameter 1.3 can be the rotational speed 3 lower than the rotational speed 2; The second group of operating parameters can be the types of materials processed by machine tools, in which the operating parameter 2.1 can be metal steel, the operating parameter 2.2 can be metal copper and the operating parameter 2.3 can be metal aluminum. In other embodiments, the operating parameters of each group may include more or less operating parameters. Referring to FIG. 2b, operating condition 1 may correspond to operation parameter 1.1 and operation parameter 2.1, and operating condition 2 may correspond to operation parameter 1.1 and operation parameter 2.2, and the corresponding relationship between operating condition 3—operating condition 9 and operation parameters will not be described here for brevity. Diagnostic models can correspond to operating conditions respectively, for example, diagnostic model 1—diagnostic model 9 correspond to operating conditions 1-9 respectively.

In one embodiment, the rotational speed of the machine tool is rotational speed 2 and the material processed by the machine tool is aluminum, so as described with reference to FIGS. 1a-1c, it can be determined that the data about the mechanical equipment belongs to the existing operating condition through the anomaly detection model and it can be determined that the data about the mechanical equipment belongs to the operating condition 6 through the classification model, so as to select the diagnosis model 6 for diagnosis and obtain the diagnosis result. The diagnostic model 6 can be trained using data belonging to the operating condition 6. Since the diagnosis model 6 is trained by using data satisfying both the operation parameters 1.2 and 2.3, the diagnosis result obtained by the diagnosis model 6 can be more accurate than that obtained by the general diagnosis model, which is more significant in the case of more operation parameter groups.

FIG. 2c is another diagram of operating conditions and a diagnosis models according to an embodiment of the present disclosure.

As shown in FIG. 2c, in an embodiment where the example mechanical equipment has more than one group of operating parameters, each operating condition may be associated with one group of operating parameters. For example, an example machine may have two groups of operating parameters including a first group of operating parameters and a second group of operating parameters. In other embodiments, example mechanical equipment may have more groups of operating parameters. In the embodiment where the mechanical equipment is a machine tool, the first group of operating parameters can be the rotational speed of the machine tool, where the operating parameter 1.1 can be the rotational speed 1, the operating parameter 1.2 can be the rotational speed 2 lower than the rotational speed 1, and the operating parameter 1.3 can be the rotational speed 3 lower than the rotational speed 2; the second group of operating parameters can be the types of materials processed by machine tools, in which the operating parameter 2.1 can be metal steel, the operating parameter 2.2 can be metal copper and the operating parameter 2.3 can be metal aluminum. In other embodiments, the operating parameters of each group may include more or less operating parameters. Referring to FIG. 2c, operating condition 1 may correspond to operating parameter 1.1 and operating condition 2 may correspond to operating parameter 1.2, and the corresponding relationship between operating conditions 3-6 and operating parameters will not be described here for brevity. The diagnosis models may correspond to operating conditions respectively, for example, the diagnosis models 1-6 correspond to operating conditions 1-6 respectively.

In one embodiment, the rotational speed of the machine tool is rotational speed 2 and the material processed by the machine tool is aluminum. Therefore, as described with reference to FIGS. 1a-1c, it can be determined that the data about the mechanical equipment belongs to the existing operating condition through the anomaly detection method, and it can be determined that the data about the mechanical equipment belongs to the operating condition 2 and the operating condition 6 through the classification method, so that the diagnosis model 2 and the diagnosis model 6 are selected for diagnosis to obtain two diagnosis results. The diagnostic model 2 can be trained using data belonging to the operating condition 2. The diagnostic model 6 can be trained using data belonging to the operating condition 6. The two diagnosis results can be combined to obtain the final diagnosis result. For example, combining may include assigning weights to the two diagnostic results. Because each operating condition is only associated with the operating parameters of one group, the number of diagnostic models can be reduced, thus saving the development cost and storage space, which is more obvious when there are more operating parameter groups. By invoking multiple diagnosis models that meet the operating conditions and combining the diagnosis results, relatively accurate diagnosis results can be obtained.

FIG. 3 is a schematic diagram of a system according to an embodiment of the present disclosure.

Although a storage is not shown in FIG. 3, one of ordinary skill in the art will understand that a processor may include one or more storages having instructions and/or data stored thereon. In addition, although FIG. 3 functionally shows the processor 320 and the sensor unit 310 as being in a single frame, those skilled in the art will understand that the processor 320 and the sensor unit 310 may actually include a plurality of processors 320 and a plurality of sensor units 310, which may or may not be stored in the same physical housing. Therefore, references to processors 320 and sensor units 310 will be understood to include references to a set of processors 320 and a set of sensor units 310 operating in parallel or not.

The processor 320 may be any conventional processing unit, such as a commercial CPU. Alternatively, the processor 320 may be a dedicated device, such as an ASIC or other hardware-based control unit.

The sensor unit 310 may include more or fewer kinds of sensors than the various sensors shown in FIG. 3.

In one embodiment, vibration sensors may include, but are not limited to, mechanical vibration sensors, optical vibration sensors, and electrical vibration sensors (such as inductive vibration sensors, eddy current vibration sensors, capacitive vibration sensors, resistance strain vibration sensors, and piezoelectric vibration sensors).

In one embodiment, the sound sensor may include, but is not limited to, a piezoelectric ceramic acoustic sensor, a capacitive acoustic sensor, a magnetoelectric acoustic sensor, and the like.

In one embodiment, chemical composition sensors may include, but are not limited to, viscosity sensors (for example, various viscosity sensors based on capillary method, falling ball method, vibration method, rotation method, ultrasonic wave, optical technology, electromagnetic principle and electromagnetic tomography technology), dielectric constant sensors (for example, capacitive, quartz crystal microbalance type), particle number sensors (for example, fluid condition monitor (FCM) and quantitative debris monitor (QDM), metal particle detector (MPD), tracer debris measuring instrument, ferrograph, acoustic emission debris detection technology, ultrasonic debris monitoring method, optical debris sensor, etc).

In one embodiment, the image sensor may include, but is not limited to, a charge coupled device (CCD) image sensor, a complementary metal oxide semiconductor (CMOS) image sensor, and the like.

In one embodiment, force sensors may include, but are not limited to, multi-component force sensors (e.g., two-component, three-component, four-component and six-component force sensors), torque sensors (e.g., dynamic torque sensors and static torque sensors) and acceleration sensors (e.g., uniaxial acceleration sensors and triaxial acceleration sensors).

In one embodiment, the voltage sensor may include, but is not limited to, a voltage transformer, a Hall voltage sensor, an optical fiber voltage sensor, and the like.

In one embodiment, the current sensor may include, but is not limited to, a shunt, an electromagnetic current transformer, an electronic current transformer, and the like.

In one embodiment, the temperature sensor may include, but is not limited to, contact temperature sensors (such as bimetal thermometers, glass liquid thermometers, pressure thermometers, resistance thermometers, thermistors, thermocouples, etc.) and non-contact temperature sensors (such as various non-contact temperature sensors based on radiation thermometry including luminance method, radiation method and colorimetry method).

In one embodiment, the speed sensor may include, but is not limited to, a photoelectric speed sensor, a magnetoelectric speed sensor, a Hall speed sensor, and the like.

The connection between the processor 320 and the sensor unit 310 may be any connection that can at least transmit the data about the mechanical equipment output by the sensor to the processor 320. In one embodiment, the connection part includes one or both of a cable connection form and a wireless connection form.

The connection part in the form of cable connection may include cables for transmitting analog signals (for example, voltage and 4-20 mA current) or digital signals (pulse, CAN, RS485, etc.). The connection part in the form of cable is more suitable for applications that need high performance acquisition and high reliability.

The connection part in the form of wireless connection may include various configurations and protocols including short-range communication protocols such as Bluetooth™, Bluetooth™LE, Sub GHz, wireless HART, infrared link, ZigBee, Radio Frequency Identification (RFID), WiFi, Internet, World Wide Web, Intranet, Virtual Private Network, Wide Area Network, Local Area Network, private network using communication protocols exclusive to one or more companies, Ethernet and HTTP, and various cellular communication technologies such as GSM, CDMA, UMTS, EV-DO, WiMAX and LTE or 5th generation “5G” cellular technology and other cellular technology developed in the future. The connection part in the form of wireless connection is more suitable for the requirements of easy installation and small size.

As described with reference to FIGS. 1a and 1b, the processor 320 may use the anomaly detection model to determine whether the data about the mechanical equipment belongs to a known operating condition. Anomaly detection models can include statistical models, anomaly detection models using machine learning and other models. For the sake of brevity, the same parts will not be described repeatedly.

As described with reference to FIGS. 1a and 1b, in the case that the processor 320 determines that the data about the mechanical equipment belongs to a known operating condition, the processor 320 may determine the operating condition of the data about the mechanical equipment using the classification model, and select a diagnosis model from the diagnosis model library 350 for diagnosis based on the operating condition. For example, when it is determined that the data about mechanical equipment belongs to a certain operating condition (for example, a certain operating speed), a diagnosis model that also belongs to the operating condition (for example, the operating speed) can be selected for diagnosis. The diagnosis model can correspond to the existing operating conditions respectively. For the sake of brevity, the same parts will not be described repeatedly.

As described with reference to FIGS. 1a and 1b, in the case that the processor 320 determines that the data about the mechanical equipment does not belong to the known operating condition, the processor 320 may report the data about the mechanical equipment. For example, the data of the mechanical equipment can be reported to a service factory 360 including a human operator for further processing. The service factory 360 may include a human operator or a processing device with higher computing power. The service factory 360 can share the anomaly detection model, classification model and diagnosis model library (if necessary) between different mechanical devices in real time.

For example, the service factory 360 can share the data of the same type of sensors of the same kind of mechanical equipment under the same operating conditions in real time, so that different service factories can use richer data to develop and train the anomaly detection model 330, the classification model 340 and the diagnosis models in the diagnosis model library 350.

In one embodiment, the service factory 360 may determine whether the data about the mechanical equipment is a new operating condition. For example, the service factory 360 may determine that the data about the mechanical equipment is a new operating condition based on the data about the mechanical equipment (e.g., its features). In this case, the service factory 360 can add the new operating condition to the known operating condition. In this way, a new diagnosis model can be developed based on the new operating conditions to update the diagnosis model library 350. In addition, the service factory 360 can update the anomaly detection model 330 and the classification model 340 based on the known operating conditions including the new operating conditions. In the case that it is determined that the data about the mechanical equipment is not a new operating condition, the service factory 360 may discard the data about the mechanical equipment. For example, if it is determined that the data about the mechanical equipment is noise, the service factory 360 may discard the data without further analysis.

One or more of the processor 320, the anomaly detection model 330, the classification model 340, and the diagnosis model base 350 in FIG. 3 may be cloud-based, which may be beneficial in the case of insufficient local computing power and storage space or smooth communication. One or more of the processor 320, the anomaly detection model 330, the classification model 340, and the diagnosis model base 350 in FIG. 3 may be edge-based, which may be beneficial when the local computing power and storage space are sufficient or communication is blocked.

According to an embodiment of the present disclosure, a computer-readable medium is provided, on which computer instructions are stored, which, when executed by a processor, cause the processor to execute a fault diagnosis method of mechanical equipment.

Examples of storage media for providing program codes include floppy disks, hard disks, magneto-optical disks, optical disks (such as CD-ROM, CD-R, CD-RW, DVD-ROM, DVD-RAM, DVD-RW), magnetic tapes, nonvolatile memory cards, and Roms. Alternatively, the program code can be downloaded from the server computer by the communication network.

According to the fault diagnosis solution of the mechanical equipment disclosed by the present disclosure, accurate fault diagnosis results can be provided even when the mechanical equipment is in different operating conditions. This method can also detect the early wear of mechanical equipment and provide maintenance suggestions for customers, so as to maintain the maintenance in the early wear stage, thus avoiding unplanned failures. By combining different operating conditions, the accuracy of fault detection can be improved and the false alarm rate can be reduced.

The text and drawings are provided as examples only to help understand the present disclosure. They should not be construed as limiting the scope of the present disclosure in any way. Although certain embodiments and examples have been provided, based on the disclosure herein, it is clear to those skilled in the art that changes can be made to the illustrated embodiments and examples without departing from the scope of this disclosure.

Although the present disclosure has been described with exemplary embodiments, various changes and modifications can be suggested to those skilled in the art. This disclosure is intended to cover such changes and modifications as fall within the scope of the appended claims.

Any description in the present disclosure should not be understood as implying that any particular element, step or function is an essential element that must be included within the scope of the claims. The scope of the patent subject matter is limited only by the claims.

What is claimed is:

1. A fault diagnosis method for mechanical equipment, comprising:
obtaining data about the mechanical equipment,
determining that the data about the mechanical equipment belongs to known operating conditions by an anomaly detection model,
determining an operating condition of the data about the mechanical equipment by the classification model, and selecting a diagnosis model for diagnosis based on the operating condition of the data about the mechanical equipment.

2. The method of claim 1, wherein the anomaly detection model comprises one or more of the following:
a statistical model and an anomaly detection model using machine learning,
wherein the anomaly detection model using machine learning includes one or more of a distribution-based machine learning model, a distance-based machine learning model, a density-based machine learning model, a clustering-based machine learning model, a tree-based machine learning model, a dimensionality reduction-based machine learning model, a classification-based machine learning model and a prediction-based machine learning model.

3. The method of claim 1, wherein the classification model comprises one or more of the following:
a data correlation model and a classification model using machine learning,
wherein the classification model using machine learning is based on one or more of decision tree, random forest, logistic regression and naive Bayes.

4. The method of claim 1, wherein the diagnosis model, the anomaly detection model and the classification model are trained by using previously obtained data about the mechanical equipment.

5. The method of claim 1, wherein obtaining the data about the mechanical equipment further comprises obtaining features of the data about the mechanical equipment, and,
wherein the features of the data about the mechanical equipment are obtained by one or more of the following:
root mean square, peak-to-peak, average, standard deviation, envelope 3, time-frequency transformation, numerical operation.

6. The method of claim 4, further comprising:
determining that the data about the mechanical equipment does not belong to the known operating conditions,
reporting the data about the mechanical equipment.

7. The method of claim 6, wherein reporting the data about the mechanical equipment further comprises:
determining whether the data about the mechanical equipment is a new operating condition,
in a case of determining that the data about the mechanical equipment is the new operating condition, the new operating condition is added to the known operating conditions,
in a case of determining that the data about the mechanical equipment is not the new operating condition, the data about the mechanical equipment is discarded.

8. The method of claim 7, further comprising:
developing a new diagnostic model based on the data about the mechanical equipment belonging to the new operating conditions, and
updating the anomaly detection model and the classification model based on the data about the mechanical equipment belonging to the known operating conditions including the new operating conditions.

9. The method of claim 1, wherein the operating conditions are associated with one or more operating parameters of the mechanical equipment.

10. A fault diagnosis system for mechanical equipment, comprising:
a sensor unit including one or more sensors and configured to collect data about the mechanical equipment;
an anomaly detection model configured to determine that data about the mechanical equipment belongs to known operating conditions;
a classification model configured to select a diagnosis model based on operating conditions of data about mechanical equipment;
a diagnosis model library including one or more diagnosis models configured to diagnose the mechanical equipment; and
a processor configured to:
obtaining the data about the mechanical equipment from the sensor unit,
determining that the data about the mechanical equipment belongs to known operating conditions using the anomaly detection model,
determining an operating condition of the data about the mechanical equipment using the classification model, and selecting a diagnosis model for diagnosis based on the operating condition of the data about the mechanical equipment from the diagnosis model library.
